(19) United States
(12) Patent Application Publication
(10) Pub. No.: US 2008/0066381 A1
(43) Pub. Date: Mar. 20, 2008

(54) Carousel Door

(76) Inventor: Manfred Rockenbach, Frechen (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/630,295

(22) PCT Filed: May 30, 2005
(86) PCT No.: PCT/EP05/05794

§ 371 Date: Dec. 19, 2006

(30) Foreign Application Priority Data
Jun. 21, 2004 (DE) 10 2004 029 762.2

(51) Int. Cl. E06B 3/90

(52) U.S. Cl. 49/44

(57) ABSTRACT

A revolving door comprising an exterior stationary drum wall having two passageways; a rotating device disposed within the stationary drum wall and comprising at least two rotating door leaves; and a deformable wall section disposed between each rotating door leaf and the stationary drum wall.

The invention relates to a revolving door with exterior, stationary drum walls and two passageways, as well as with a rotating device, which is disposed within the surrounding drum walls and comprises at least two rotating door leaves.

Such revolving doors are well known. In addition to manually operable revolving doors, other revolving doors with an electromotor drive are known, in particular with a fully automatic, micro-processor controlled drive system.

On the outside, the known revolving doors have two stationary drum walls, which include two passageways, generally located diametrically opposite each other. These two passageways, so to speak, form the “lockage” area of the revolving door. A rotating device, which has a rotating part with two, three or four leaves, is located within these round drum walls, such that door leaves directly or indirectly extend from a central, vertical axis. This rotating device is driven by means of an electromotor to perform a rotational movement, such that the door leaves rotate and, with their ends pointing to the outside, terminate with the inner sides of the curved drum walls. One problem encountered with this type of revolving doors consists in that shearing edges, between which, with rotating door leaves, the users might become stuck and thus injured, exist between the front edge of the drum walls in the area of a passageway and the door leaves. For this purpose, such revolving doors need to be equipped with appropriate safety devices, such that, in the event a user becomes stuck, the rotating device is immediately stopped. In an emergency situation, this stopping operation is not easy to perform and it also causes a lot of stress on the material. In known revolving doors, usually safety contact strips are provided at the shearing edges as a safety device, which strips upon deformation trigger an electrical alarm. Thus, the known revolving doors have a safety device in the event a user gets stuck, which safety devices work very reliably too; however, technically it is very difficult to realize the abrupt stop of the rotating device. In particular for large revolving doors this is only possible at important technical expenditure.

In particular for children or toddlers, the risk of getting stuck is very high, as they do not yet have enough body force to possibly resist the door. Therefore, in particular children and toddlers are at risk to injure themselves, if they get caught in the slot between the front edge of the drum wall in the area of a passageway and the associated door leaf.

Based on the foregoing, the object of the invention is to provide an improved revolving door, which has a more efficient anti-jamming protection in particular for children, and is less hard on the material.

According to the invention, this problem is solved for a revolving door with exterior, stationary drum walls and two passageways, as well as with a rotating device, which is disposed within the surrounding drum walls and comprises at least two rotating door leaves, in that a deformable wall is provided between the door leaf and the drum wall.

An efficient anti-jamming protection is provided by means of this embodiment. As soon as there is the risk a person could become stuck in the slot between the front edge of the drum wall in the area of the passageway and the door leaf the deformable wall is able to deform and yield, such as to eliminate the possible formation of shearing edges. This circumstance not only allows to effectively avoid injuries, but also to reduce the dimensions of the overall structural arrangement, because an abrupt stopping of the door is no longer mandatory. In particular with revolving doors having a large diameter, this results in a considerably reduced overall constructive expenditure and thus in cost savings.

Advantageous further developments will result from the dependent claims.

The deformable wall or the deformable wall section can be realized in many different ways.

According to a preferred further development, the deformable wall is formed by an air curtain. On the one side, such an air curtain not only prevents hot or cold air from entering or escaping through the revolving door but, on the other side, jamming between the front edges of the door leaf and the drum wall becomes impossible as well.

Such an air curtain is particularly easy to realize, if, according to a preferred embodiment, the air curtain exits from a vertical nozzle arrangement, which is disposed at a frontal wall of the door leaf, which wall is oriented towards the drum wall. The air is thus blown into the direction of the drum wall, which air practically forms a closed, but nevertheless flexible wall between the door leaf and the drum wall.

As an alternative, the air curtain may exit from a plurality of vertical nozzle arrangements, which are disposed in the drum wall and spaced apart from each other in circumferential direction. Thus the air curtain is blown from the drum walls into the direction of the door leaves. A control will achieve that the air curtain is exclusively generated by the nozzle arrangements which are close to a door leaf. This prevents blowing on persons passing through the revolving door.

It is particularly easy to realize the supply of air to the nozzle arrangements, if, according to a preferred embodiment, the air supply to the nozzle arrangement is realized from the top through the ceiling of the revolving door. It is likewise possible to provide a separate air supply for each leaf within the leaves.

According to an alternative embodiment, the deformable wall may be formed by a hollow body, which can be filled with a fluid. The hollow body may consist for example of a polythene bag in the shape of a flat disc, into which a fluid, e.g. air or a liquid is injected. The hollow body may be transparent or dyed, likewise the fluid can be clear or a colorant may be added. This hollow body constitutes an extension of the door leaf and swipes along the drum wall with its one end. As soon as an obstacle gets in its way, it can flexibly yield and thus avoids the formation of shearing edges.

As the deformable wall can be filled with a fluid, after a deformation it automatically returns into its initial position without requiring any constructive means. Moreover, the deformable wall can deform at any arbitrary angle such that, even under the most unfavourable conditions, a deformation of the wall is always guaranteed.

According to another alternative embodiment, the deformable wall can be formed as well by horizontally extending bristles of a brush, by flexible stripes, ribbons, strings or the like. In the event of encountering an obstacle, these will respond like the hollow body filled with fluid.

As particularly children and toddlers are most likely to run the risk of getting stuck, according to a preferred embodiment, it is intended that the deformable wall presents at least the width of a child's body. Therefore, especially a child can not become stuck between the drum wall and the leaf door.

Advantageously, in its initial position, the deformable wall is aligned substantially with the door leaf. Such an embodiment has the advantage of the deformable wall, which in the normal state acts as a security device constituting an extension of the door leaf and thus not being perceived as disturbing.

According to another embodiment, a sensor strip can be disposed at a front edge of the drum wall located at the front in the direction of rotation, which strip, as soon as the door leaf approaches an obstacle present in the area of rotation, or upon mechanical contact with such obstacle, stops a movement of the revolving door. Due to this measure, the safety of the inventive revolving door can be increased even further.

Further features and advantages of the invention will become apparent from the following description of one preferred exemplary embodiment, in which:

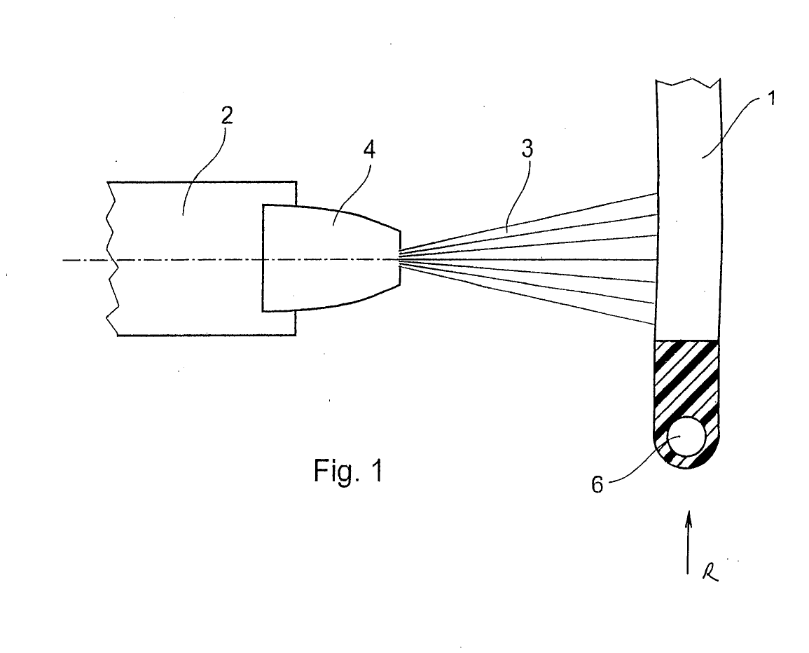

FIG. 1 shows a diagrammatical view from the top on the inventive revolving door in the area between the door leaf and the drum wall,

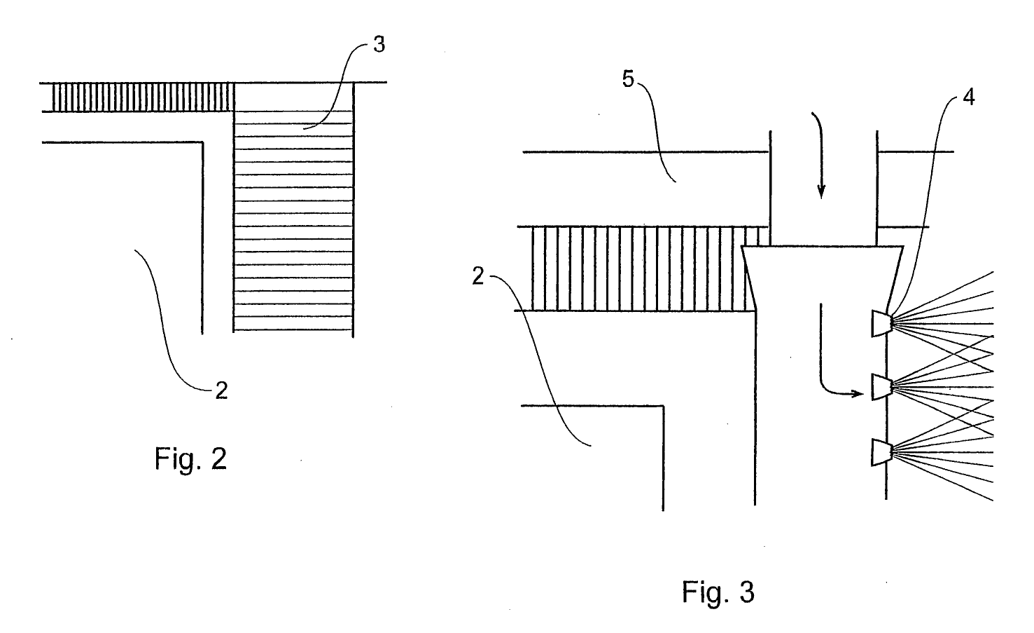

FIG. 2 shows a diagrammatical view of an inventively formed door leaf in the same area, and

FIG. 3 shows a detailed view of an inventively formed fluid supply to the door leaf.

In the illustration the revolving door is just illustrated in the area of interest here and with its relevant components, all other structural components have been omitted for clarity's sake.

In FIG. 1 the inventive revolving door is diagrammatically illustrated in a view from the top. The revolving door has exterior, stationary drum walls 1 and two passageways. A rotating device with at least two rotating door leaves 2 is disposed within the drum walls 1. However, the invention may be used with revolving doors having three or four leaves.

The illustrated revolving door has a counter-clockwise direction of rotation R. Evidently, the invention is applicable with revolving doors which rotate clockwise.

At the side thereof oriented towards the drum wall 1, each individual door leaf 2 is provided with a deformable wall 3, which measures at least about the width of a child's body. The deformable wall 3, which, in the initial position illustrated in FIG. 1, is substantially aligned with the door leaf 2, can be formed in different ways.

The deformable wall 3 may be formed e.g. by an air curtain, which exits from a nozzle arrangement 4, disposed at the front side of the door leaf 2 oriented to the drum wall 1, and is directed towards the drum wall 1.

However, the deformable wall 3 may be also formed by a hollow body which can be filled with a fluid. The hollow body may be formed e.g. by a flat polythene bag, into which a fluid (air or water) is injected. For injecting the fluid, the same nozzle arrangement 4 may be used, which is also used for generating the air curtain.

Furthermore, the deformable wall 3 may make use of flexible strips, strings, ribbons or the like, which are fixed in the area of the nozzle arrangement 4 and are entrained by the air flow in the direction of the drum wall 1.

Feeding the fluid to the nozzle arrangement 4 is realized e.g. from the top through the ceiling 5 of the revolving door, such that the fluid is introduced from the top into the door leaf 2 and is then guided within the door leaf 2, to the individual nozzles of the nozzle arrangement 4, where it exits in the direction towards the drum walls 1.

Basically it is possible to provide the nozzle arrangement 4 within the drum wall 1 and to form the deformable wall starting at the drum wall 1. For this purpose, the nozzle arrangements 4 may be disposed within the drum wall 1 and spaced apart from each other in circumferential direction. The nozzle arrangement 4 may be controlled via a control system, such that the air curtain is exclusively generated by the nozzle arrangements 4, which are close to a door leaf 2. Thus blowing on persons passing through the revolving door is prevented.

In addition to the above described embodiment having one door leaf 2 with a deformable wall 3, a sensor strip 6 may be provided at the front edge of the drum wall 1, which edge is located at the front in the direction of rotation R, which strip will stop a movement of the revolving door, in the event the strip would approach an obstacle present in the area of rotation of the door leaf 2, or upon mechanical contact with such obstacle.

### LIST OF REFERENCE NUMERALS

1 drum wall
2 door leaf
3 deformable wall
4 nozzle arrangement
5 ceiling
6 sensor strip
R direction of rotation

1.-10. (canceled)

11. A revolving door comprising:
an exterior stationary drum wall having two passageways;
a rotating device disposed within the stationary drum wall and comprising at least two rotating door leaves; and
a deformable wall section disposed between each rotating door leaf and the stationary drum wall.

12. The revolving door of claim 11, wherein each deformable wall section comprises an air curtain.

13. The revolving door of claim 12, wherein each rotating door leaf has an exterior end facing the stationary drum wall, the revolving door further comprising a vertical nozzle arrangement disposed at said exterior end of each rotating door leaf, air exiting from said vertical nozzle arrangement to form said air curtain.

14. The revolving door of claim 13, wherein the air is supplied to said nozzle arrangement through a ceiling of said each rotating door leaf.

15. The revolving door of claim 12, further comprising a plurality of vertical nozzle arrangements disposed at said stationary drum wall and spaced apart from each other in circumferential direction, wherein when each rotating door leaf rotates, air exits from one of the nozzle arrangements which is closest to said each rotating door leaf to form said air curtain.

16. The revolving door of claim 15, wherein the air is supplied to said one of the nozzle arrangements through a ceiling of said each rotating door leaf.

17. The revolving door of claim 11, wherein each deformable wall section comprises a hollow body filled with a fluid and disposed at an exterior end of a respective door leaf.

18. The revolving door of claim 11, wherein each deformable wall section is formed by bristles, flexible strips, strings or ribbons.

19. The revolving door of claim 11, wherein each deformable wall section has a width which is at least approximately equal to a width of a child's body.

20. The revolving door of claim 11, wherein each deformable wall section, when in an initial position, is substantially aligned with a respective door leaf.

21. The revolving door of claim 11, wherein the stationary drum wall comprises drum wall sections, each drum wall section having a front edge facing a rotation direction of the rotating door leaves, the revolving door further comprising a sensor strip disposed at said front edge of each drum wall section, each sensor strip being operable to stop rotation of the rotating door leaves upon sensing or physically contacting an obstacle.
